(19) United States
(12) Patent Application Publication
(10) Pub. No.: US 2025/0305484 A1
(43) Pub. Date: Oct. 2, 2025

(54) WIND TURBINE ROTOR BLADE HAVING A BASE PLATE WITH ACCESS OPENING

(71) Applicant: Nordex Energy SE & Co. KG, Hamburg (DE)

(72) Inventor: Peter Baars, Krusenhagen (DE)

(21) Appl. No.: 19/091,664

(22) Filed: Mar. 26, 2025

(30) Foreign Application Priority Data
Mar. 27, 2024 (DE) 10 2024 108 676.9

(51) Int. Cl. F03D 80/50

(52) U.S. Cl. CPC F03D 80/502; F05B 2240/21; F05B 2240/30

(57) ABSTRACT

A wind turbine rotor blade has a base plate having an access opening, and having a cover via which the access opening can be closed. A holding arrangement is configured such that a movement of the cover relative to the base plate in a predetermined direction parallel to the plane of the base plate causes the cover to be held in a form-fitting manner on the base plate, and a locking device blocks a movement of the cover in a direction opposite to the predetermined direction.

### CROSS-REFERENCE TO RELATED APPLICATIONS

This application claims priority of German patent application no. 10 2024 108 676.9, filed Mar. 27, 2024, the entire content of which is incorporated herein by reference.

### TECHNICAL FIELD

The disclosure relates to a wind turbine rotor blade having an interior space, a base plate that delimits the interior space and that includes an access opening, and a cover via which the access opening can be closed.

### BACKGROUND

Wind turbine rotor blades include a base plate which is generally arranged at the blade root end of the wind turbine rotor blade and which is occasionally referred to as a bulkhead. The base plate delimits the interior space of the rotor blade and has various functions: The base plate can reinforce the region of the blade root, serve as a platform for maintenance personnel, and/or be used for mounting assemblies, for example for a de-icing system. Moreover, the base plate prevents objects from entering the hub from the rotor blade and vice versa during operation. For example, adhesive residues that should not fall into the hub may become detached inside the rotor blade.

For maintenance work inside the rotor blade, the base plate has an access opening through which a person can climb into the interior space. For maintenance work in the hub, the base plate also serves as a standing platform, in which case the access opening must be securely closed.

Closure or cover plates which are screwed to the base plate can be used to close the access opening. Covers which are braced via clamping elements that engage behind the base plate at the edge of the access opening are also known.

EP 1 925 818 A2 discloses wind turbine rotor blades which include an access opening with a hatch flap in the base plate. Hatch flaps of this kind are pivotably articulated to a frame inserted in the base plate and can be locked in the closed position via rotary handles.

### SUMMARY

Proceeding from this, an object of the disclosure is to provide a wind turbine rotor blade having a base plate, the access opening of which can be closed securely with simple means and with a minimal risk of maloperation.

The wind turbine rotor blade has a base plate including an access opening, and a cover via which the access opening can be closed, and is characterized by:
a holding arrangement which is configured such that a movement of the cover relative to the base plate in a predetermined direction parallel to the plane of the base plate causes the cover to be held in a form-fitting manner on the base plate, and
a locking device which blocks a movement of the cover in a direction opposite to the predetermined direction.

The cover can be fully removed from the base plate, and a permanent connection, for example via a hinge, is not provided. Nevertheless, secure closure of the access opening thanks to the holding arrangement and the locking device is possible in a very simple manner: After the cover has been brought up to the base plate, a movement in a predetermined direction parallel to the plane of the base plate is sufficient for holding the cover on the base plate in a form-fitting manner. The cover is then already held on the base plate such that it can no longer fall down. However, the form-fitting hold can be overridden at any time by moving the cover relative to the base plate counter to the previously performed movement.

For this reason, a locking device which blocks this very return movement is provided for securely fastening the cover to the base plate. Since every other conceivable movement is already prevented by the form-fitting hold produced by the holding arrangement, the cover is firmly secured to the base plate after the locking device becomes active and can only be detached again after the locking device has been released.

Advantages of the disclosure include in the particularly simple configuration and the particularly simple handling of the cover. In particular, it is not necessary to brace the components together as is known from the prior art in order to securely fasten the cover to the base plate. The force-locking hold achieved via bracing is, in principle, less reliable than the form-fitting hold provided in the disclosure. In addition, bracing generally requires multiple handles in order to brace the cover to the base plate at multiple points. Furthermore, the dimensions of the components to be braced together must be precisely coordinated, in particular tensioning elements that are typically used which engage behind the base plate at the edge of the access opening must be coordinated with the thickness of the base plate. The holding arrangement provided in the disclosure can be used much more easily and universally in comparison, in particular it can be readily combined with base plates of different thicknesses.

On the one hand, the structural simplification results from an accordingly simply configured holding arrangement and, on the other hand, the cooperation of the cover with the base plate can be maintained particularly easily via the holding arrangement. In particular, the cover can be held in a form-fitting manner completely on one side of the base plate, that is, without reaching into the access opening and/or without cooperating with or engaging behind an opening edge of the access opening. Precise adaptation of the cover to the dimensions of the access opening is therefore not required in this context either. It is sufficient if the cover is sufficiently large to close the access opening in the desired manner and if the holding arrangement is fastened such that it can fulfill its function. For this purpose, the holding arrangement can be fastened to the base plate in particular in a position predetermined by the configuration of the cover.

The holding arrangement may be arranged entirely on the same side of the base plate on which the cover is also arranged. The regions located on the side of the base plate facing away from the cover can remain untouched. In this case, the proper condition of the fastening can be checked entirely from the side of the base plate on which the cover is arranged.

In principle, the movement of the cover relative to the base plate may be a translational movement in the predetermined direction, preferably in a direction from above downwards, for example by hooking the cover into a hook-shaped holding arrangement. However, since the orientation of the rotor blade and thus of the base plate varies during maintenance work in the rotor of the wind turbine, in a preferred embodiment the movement is a rotational movement. The cover is therefore moved up to the base plate and then rotated by a predetermined angle, in particular, for example, about a center point of the cover. The holding arrangement may be configured such that it guides the rotational movement.

In various embodiments, the holding arrangement includes multiple guide slots which extend in each case in the predetermined direction and multiple pins that cooperate with the guide slots and that engage therein, wherein the guide slots are arranged on the cover and the pins are arranged on the base plate or vice versa. “Or vice versa” means that the pins are arranged on the cover and the guide slots are arranged on the base plate. The guide slots produce the aforementioned guiding, and the pins move in the guide slots when the relative movement is performed. In the variant with a rotational movement, the guide slots may extend around the center point of the rotational movement on sections of circular paths. In particular, the pins may each include a head, the width of which is greater than the width of the guide slot cooperating therewith. After the pin has been introduced into the associated guide slot, the pin can then no longer “slide out” of the guide slot by mistake.

In various embodiments, the guide slots and the pins are arranged asymmetrically with respect to one another, such that the cover can only be arranged in a single orientation on the base plate in such a way that the pins engage in the guide slots. For example, the guide slots (and thus also the pins) are arranged in a circle, for example at the edge of a circular cover. The spacings between the guide slots can be selected such that at least one of the guide slots deviates from a uniform spacing pattern. This ensures that the cover is always mounted in the same orientation. This may be of importance, for example, if handles are arranged on the cover which should always be located in a position that is favorable for gripping or which could collide, for example, with a ladder to be erected in the region of the passage opening in the event of incorrect positioning.

In various embodiments, the guide slots are keyhole-shaped elongate holes. The elongate holes have a circular portion and a slot-shaped portion, wherein the width of the slot-shaped portion is less than the diameter of the circular portion. The pins are coordinated with the dimensions of the elongate holes in such a way that their heads can be guided through the circular region of the elongate hole and, after the intended movement has been performed, the pin engages in the slot-shaped region of the elongate hole, such that the head engages behind the slot. It is particularly intuitive and simple to handle a cover with keyhole-shaped elongate holes, because it is only possible to place the cover in a single, predetermined, and easily detectable position and the movement to be performed for activating the holding arrangement is determined by the shape of the guide slots.

In various embodiments, threaded sleeves in which the pins are screwed are inserted in the base plate. The threaded sleeves include an internal thread and the pins include a matching external thread. This solution allows for simple and secure fastening of the pins in the base plate. The base plate typically consists of a fiber-reinforced plastics material, often in a sandwich configuration. A threaded sleeve with a relatively large outer diameter can be fastened particularly simply and securely in this material, for example by being glued in a suitable bore. For this purpose, the pin itself has a diameter that is too small. A further simplification can be achieved when using a threaded sleeve in the form of a self-tapping threaded insert. The threaded insert can be easily screwed into an aforementioned bore, in particular into a blind bore. In principle, it is of course also possible to guide the pins through the base plate and secure them on the rear side, for example via a nut. However, this is more laborious and not required for secure fastening.

In various embodiments, the pins are collar screws. The collar screws each have a threaded portion, which is preferably screwed into the threaded sleeve, and a step/collar or circumferential collar between the threaded portion and a head optionally formed on the other end, which step or collar is supported on the threaded sleeve or on the outer side of the base plate after the threaded portion has been fully screwed into the threaded sleeve and which allows for firm securing precisely in the desired position. Collar screws are, like the aforementioned threaded sleeves, available as standardized components made of different suitable materials, which contributes to a cost-effective configuration.

In various embodiments, the base plate includes a ring which consists of a fiber composite material and which delimits the access opening. Outside the ring, the base plate may, in particular, be manufactured in a sandwich configuration, that is, have a core material that is arranged between two cover layers forming the outer sides of the base plate and, in particular, consisting of a fiber composite material. The ring may, in particular, consist of a full laminate material. This increases the strength of the base plate in the region of the access opening and simplifies secure anchoring of the holding arrangement in the region of the ring.

In various embodiments, the locking device includes a snap-in mechanism which engages after the movement of the cover relative to the base plate has been completed. In this case, the locking takes place automatically without corresponding locking elements having to be manually actuated. This contributes to the security of the fastening, in particular if the engagement of the locking elements can be clearly perceived by an operator. Then, the operator will perform the movement automatically and completely such that the locking device engages properly.

In various embodiments, the snap-in mechanism includes at least one locking pin which assumes a locked position via spring force. This leads to secure locking.

In various embodiments, the snap-in mechanism includes a display which displays a snapped-in position of the snap-in mechanism. In this case, the operator obtains visual feedback about proper locking. This remains permanently visible, such that proper locking can be verified at any time.

In various embodiments, a marking that indicates the arrangement of the cover in a properly closed position is arranged on the base plate and/or on the cover. This allows for an additional or alternative check as to whether the cover has been correctly secured to the base plate.

In various embodiments, the cover includes two handles. The two handles are preferably arranged on opposing sides of the cover. By virtue of the handles, the cover can be easily handled.

In various embodiments, the cover is a metal plate, preferably a plate that consists of aluminum and that may be circular. In this variant, the cover is very light but still robust and readily suitable as a standing platform.

In various embodiments, the locking device includes two locking elements which are arranged adjacently to the handles. In a locked position, the two locking elements produce secure locking. The arrangement in the region of the handles simplifies operation of the locking elements, in particular when releasing the locking device. In particular, the cover can be held by the handles using hands while the locking elements are released or in any case immediately after the locking device is released. This increases safety in particular during removal of the cover, because it prevents the cover from unintentionally moving out of the holding arrangement after the locking device is released.

### BRIEF DESCRIPTION OF DRAWINGS

The invention will now be described with reference to the drawings wherein:

FIG. 1 shows the blade root end of a wind turbine rotor blade with base plate and cover;

FIG. 2 shows a detail of the base plate from FIG. 1 with the cover removed;

FIG. 3A shows the cover from FIG. 1 in a plan view;

FIG. 3B shows a variant of the cover from FIG. 3A;

FIG. 4 shows an enlarged detail from FIG. 3B;

FIG. 5 shows a portion of the cover in a position locked to the base plate;

FIG. 6 shows a sectional representation of the arrangement from FIG. 5; and,

FIG. 7 shows another sectional representation of the arrangement from FIG. 5.

### DETAILED DESCRIPTION

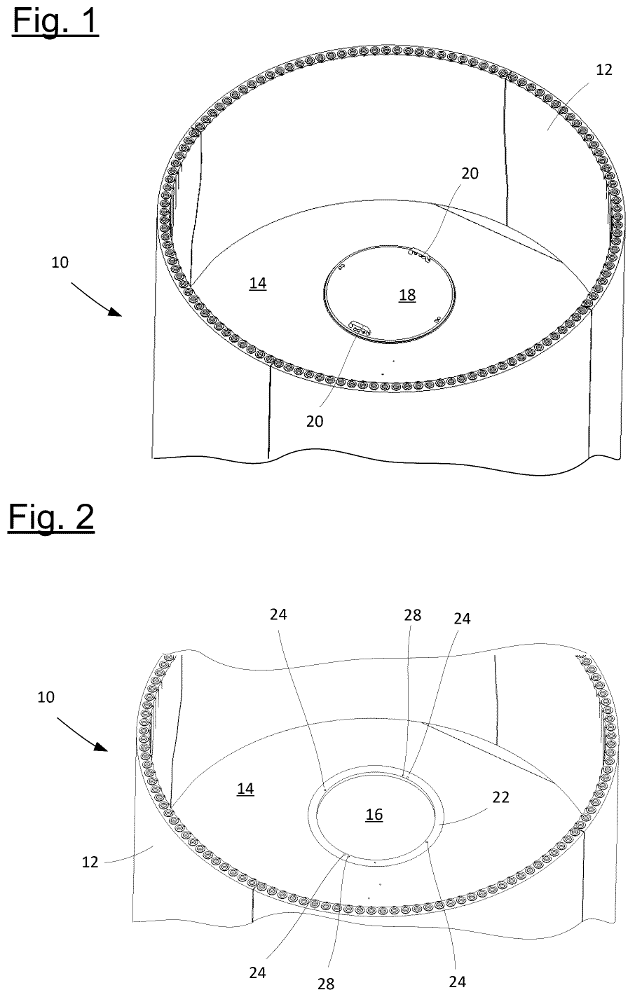

FIG. 1 shows the blade root end of a wind turbine rotor blade 10 in a perspective view. Near to the blade root 12, the rotor blade has an approximately circular-cylindrical portion in which a base plate 14 is arranged. The base plate is manufactured in a sandwich configuration and is used, inter alia, to reinforce the blade root 12. The base plate 14 includes an access opening 16 (see FIG. 2) which is closed via a cover 18. The cover 18 is a circular metal plate having two handles 20. The details are better discernible in the following figures.

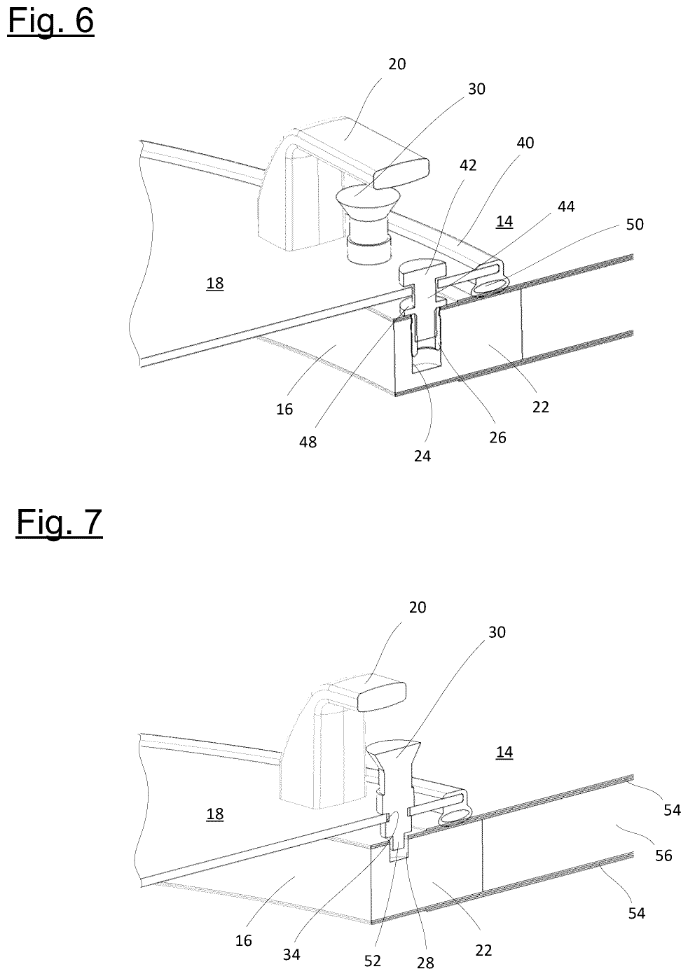

FIG. 2 shows a detail of the base plate 14 from FIG. 1 with the cover 18 removed. The circular access opening 16 can be seen, which, in the example, has a diameter of approximately 60 cm, such that a person can easily enter the interior of the wind turbine rotor blade 10. The access opening 16 is delimited by a ring 22 which consists of a fiber composite material and which is an integral component of the base plate 14. FIG. 2 also shows the arrangement of four bores 24, which each receive a threaded sleeve 26 (see FIG. 6), and two smaller bores 28, in each of which a locking pin 30 (see FIG. 7) can engage.

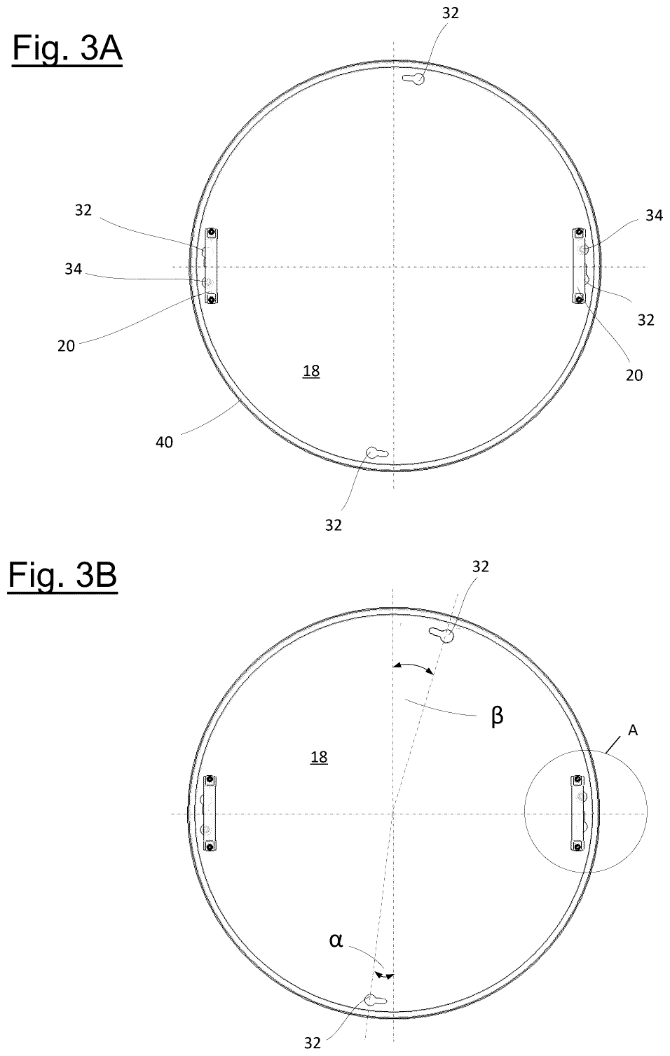

FIG. 3A shows a plan view of the cover 18. The cover 18 includes four keyhole-shaped elongate holes 32, two of which are arranged opposite one another and are in each case arranged adjacently to one of the handles 20. Two further keyhole-shaped elongate holes 32 can be seen in FIG. 3A at the top and bottom, approximately centrally between the two handles 20. They are arranged so as to be offset relative to the other two keyhole-shaped elongate holes 32 close to the handles 20 by a little more than 90°, such that the cover 18 cannot be mounted in a position that is rotated by 90°, since the locking pins would not come into contact with the corresponding bores in this position. A small bore 34 for a locking pin 30 is located adjacently to each of the two handles 20.

FIG. 3A also shows a rubber seal 40 that surrounds the entire cover 18 and that, in particular, prevents the cover 18 from rattling in the position mounted on the base plate 14. At the same time, the circumferential seal 40 protects against injuries on the edges of the cover 18 during handling thereof.

FIG. 3B shows a variant of a cover 18 which is equivalent to FIG. 3A with regard to the handles 20 and the elongate holes 32 arranged close to the handles 20. However, the other two elongate holes 32, which are arranged between the handles 20 in FIG. 3B, are arranged asymmetrically, unlike in FIG. 3A, such that the cover 18 can only be mounted in a single rotational position. The handles 20 and the elongate holes 32 arranged close to the handles 20 are arranged on a horizontal line. The upper elongate hole 32 is arranged so as to be offset by an angle β and the lower elongate hole 32 by an angle α, which is different to β, relative to a vertical line.

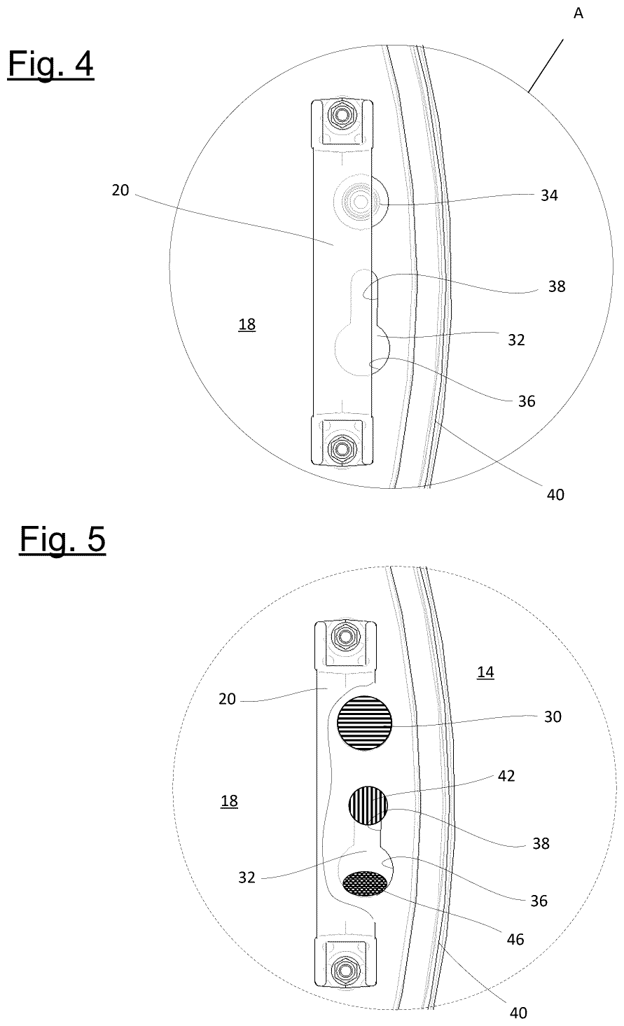

In FIG. 4, the handle 20 located to the right in FIG. 3B is represented in an enlarged manner, together with the adjacent elongate hole 32 and the bore 34. The keyhole shape of the elongate hole 32 is clearly visible, with a circular portion 36 and a slot-shaped portion that forms a guide slot 38.

FIG. 5 shows a detail of the cover 18 with a handle 20 in the position fastened to the base plate 14. The head 42 of a collar screw 44 (see FIG. 6) can be seen, which, together with the elongate hole 32, forms a holding arrangement for the cover 18 to the base plate 14. The position shown in FIG. 5 is achieved after the cover 18 has been brought up to the base plate 14 in a position wherein the head 42 has been inserted in the circular portion 36 of the elongate hole 32 and after a rotational movement by approx. 3° clockwise has been performed. In the position achieved then, the head 42 engages behind the guide slot 38, such that the cover 18 is held on the base plate 14 in a form-fitting manner.

FIG. 5 also shows a locking pin 30, which is fastened in the bore 34 (see FIG. 2) of the cover 18 and engages in the bore 28 in the base plate 14 in order to lock the rotational movement.

Finally, FIG. 5 shows a marking 46 on the base plate 14, which becomes visible on the lower edge of the circular portion 36 of the elongate hole 32 after the cover 18 has been rotated into the intended position. The visibility of the marking 46 through the elongate hole 32 indicates that the intended rotational position has been achieved.

In the sectional representation of FIG. 6, one of the bores 24 in the base plate 14 in the region of the ring 22 of the base plate 14 as well as the threaded sleeve 26 inserted therein are visible. The collar screw 44 is screwed into the threaded sleeve 26. The circumferential collar 48 of the collar screw 44 is braced with the threaded sleeve 26 and/or with the upper side of the base plate 14. The head 42 of the collar screw and the longitudinal portion with a smaller diameter located between the collar 48 and the head 42 are also clearly visible. Moreover, FIG. 6 shows the circumferential seal 40, which has been pushed onto the edge of the cover 18 and which includes an elastically deformable portion 50 between the cover 18 and the base plate 14.

FIG. 7 shows another sectional representation similar to FIG. 6, but the sectional plane here extends through the locking pin 30. It can be seen that the locking pin is inserted in the bore 34 of the cover 18 and includes a spring portion 52 which engages in the correspondingly arranged bore 28 in the base plate 14. In order to release this lock, the locking pin 30 can be pulled out a little by the enlarged head thereof by hand counter to the force of the spring.

FIG. 7 also reveals the structure of the base plate 14 in a sandwich configuration with two cover layers 54 and a core material 56 arranged therebetween. In the region of the access opening 16, the ring 22 made of full laminate material is located between the cover layers instead of the core material 56.

It is understood that the foregoing description is that of the preferred embodiments of the invention and that various changes and modifications may be made thereto without departing from the spirit and scope of the invention as defined in the appended claims.

### LIST OF REFERENCE SIGNS

10 Wind turbine rotor blade
12 Blade root
14 Base plate
16 Access opening
18 Cover
20 Handle
22 Ring
24 Bore
26 Threaded sleeve
28 Bore
30 Locking pin
32 Elongate hole
34 Bore
36 Circular portion
38 Guide slot
40 Seal
42 Head
44 Collar screw
46 Marking
48 Collar
50 Elastic portion
52 Spring portion
54 Cover layer
56 Core material

1. A wind turbine rotor blade comprising:
a base plate having an access opening and defining a base plane;
a cover for closing said access opening;
a holding arrangement configured to permit a movement of said cover relative to said base plate in a predetermined direction parallel to said base plane of said base plate so as to cause said cover to be held in a form-fitting manner on said base plate; and,
a locking device configured to block a movement of said cover in a direction opposite to said predetermined direction.

2. The wind turbine rotor blade of claim 1, wherein said movement is a rotational movement.

3. The wind turbine rotor blade of claim 1, wherein said holding arrangement comprises a plurality of guide slots each extending in said predetermined direction and a plurality of pins that coact with said guide slots so as to engage therein; and, one of the following applies: i) said guide slots are arranged on said cover and said pins are arranged on said base plate or ii) said guide slots are arranged on said base plate and said pins are arranged on said cover.

4. The wind turbine rotor blade of claim 3, wherein said guide slots and said pins are arranged asymmetrically with respect to one another so as to cause said cover to be arrangeable only in a single orientation on said base plate so as to cause said pins to engage in said guide slots.

5. The wind turbine rotor blade of claim 3, wherein said guide slots are keyhole-shaped elongate holes.

6. The wind turbine rotor blade of claim 3, further comprising a plurality of threaded sleeves inserted in said base plate and threadably engaging corresponding ones of said pins.

7. The wind turbine rotor blade of claim 3, wherein said pins are collar screws.

8. The wind turbine rotor blade of claim 1, wherein said base plate comprises a ring including a fiber composite material and delimiting said access opening.

9. The wind turbine rotor blade of claim 1, wherein said locking device comprises a snap-in mechanism configured to engage after the movement of said cover relative to said base plate has been completed.

10. The wind turbine rotor blade of claim 9, wherein said snap-in mechanism comprises at least one locking pin which assumes a locked position via spring force.

11. The wind turbine rotor blade of claim 9, wherein said snap-in mechanism comprises a display showing an engaged position of said snap-in mechanism.

12. The wind turbine rotor blade of claim 1, wherein a marking indicating said cover is in a properly closed position is provided on said base plate and/or on the cover.

13. The wind turbine rotor blade of claim 1, wherein said cover comprises two handles.

14. The wind turbine rotor blade of claim 13, wherein said locking device comprises two locking elements arranged adjacently to said handles.

15. A wind turbine rotor blade comprising:
a base plate having an access opening and defining a base plane;
a cover for closing said access opening;
a holding arrangement configured to permit a movement of said cover relative to said base plate in a predetermined direction parallel to said base plane of said base plate so as to cause said cover to be held in a form-fitting manner on said base plate;
a locking device configured to block a movement of said cover in a direction opposite to said predetermined direction;
said base plate having a main body and a ring delimiting said access opening and being made of a fiber composite material; and,
said main body having a sandwich configuration including two cover layers and a core layer disposed between said two cover layers and made of fiber composite material.

16. The wind turbine rotor blade of claim 15, wherein said two cover layers extend beyond said main body with said ring therebetween.

17. A wind turbine rotor blade comprising:
a base plate having an access opening and defining a base plane;
a cover for closing said access opening;
a holding arrangement configured to permit a movement of said cover relative to said base plate in a predetermined direction parallel to said base plane of said base plate so as to cause said cover to be held in a form-fitting manner on said base plate;
a locking device configured to block a movement of said cover in a direction opposite to said predetermined direction;
said base plate having a main body and a ring delimiting said access opening and being made of laminate material to increase the strength of said base plate in the region of said access opening; and,
said main body having a sandwich configuration including two cover layers and a core layer disposed between said two cover layers and made of fiber composite material.

18. The wind turbine rotor blade of claim 17, wherein said two cover layers extend beyond said main body with said ring therebetween.
